(19) United States
(12) Patent Application Publication
(10) Pub. No.: US 2025/0100308 A1
(43) Pub. Date: Mar. 27, 2025

(54) INK JET PPRINTING APPARATUS

(71) Applicant: MIYAKOSHI PRINTING MACHINERY CO., LTD., Narashino-city (JP)

(72) Inventors: Junichi SETOYAMA, Yachimata-city (JP); Yuuichi YAMAZAKI, Kashiwa-city (JP)

(21) Appl. No.: 18/894,643

(22) Filed: Sep. 24, 2024

(30) Foreign Application Priority Data
Sep. 25, 2023 (JP) 2023-161699

(51) Int. Cl. B41J 25/34

(52) U.S. Cl. CPC B41J 25/34

(57) ABSTRACT

An ink jet printing apparatus includes a printing part that includes head parts each including a head main body part and a base part provided at a peripheral edge of the head main body part, a line block frame for supporting the base part from below, and an urging device for attaching the base part to the line block frame with the base part urged toward the line block frame, the urging device includes a shaft part attached to the line block frame, a bracket part attached via a bearing part to enable up-down movement along the shaft part, a spring part for urging the bracket part downward, and a lock pin protruding downward from the bracket part, the lock pin is arranged on an upper surface of the base part at the time of urging, and the lock pin is lifted upward at the time of releasing urging.

### TECHNICAL FIELD OF THE INVENTION

The present invention relates to an ink jet printing apparatus including a head part capable of ejecting an ink.

### BACKGROUND OF THE INVENTION

In an ink jet printing apparatus of a line head type, a head part is fixed, and an ink changed into small droplets is ejected from the head part into a medium to be printed that passes below the head part, thereby performing printing.

Generally, a plurality of head parts are simultaneously used, and there exist various structures for attaching the head parts.

For example, there has been known an ink jet recording apparatus (ink jet printing apparatus) in which a head substrate 12 to which a line head having a plurality of short heads 11 arranged therein in a staggered shape is attached to a carriage 9 to perform ink jet recording with the line head on a recording medium 2 positioned on the underside of the carriage 9 (see, for example, Japanese Patent Laid-Open No. 2010-173232).

In the ink jet printing apparatus, attachment of each of the short heads 11 (the head parts) to a head attachment surface 27 is performed by fastening flanges 29a and 29b provided on both sides in a longitudinal direction of the short head 11, respectively, with fixing screws 30 to be screwed into the head attachment surface 27.

There has been known an ink jet printing apparatus in which a plurality of line heads each having a large number of ink jet nozzles provided therein in a columnar shape are arranged in a printing direction (see, for example, Japanese Patent Laid-Open No. 2011-152708).

In the ink jet printing apparatus, there are provided first and second fixing pins 17 and 18 that press and fix respective upper surfaces of flanges 5 and 7 on both sides of a line head 3 (a head part), and brackets 19 and 20 to which the fixing pins 17 and 18 are fastened are fixed to a line head frame 2, respectively, with fixing bolts 21 and 22.

### SUMMARY OF THE INVENTION

However, the above-described ink jet printing apparatuses disclosed in Japanese Patent Laid-Open Nos. 2010-173232 and 2011-152708 have disadvantages that it takes time to attach and detach a head part and the efficiency of maintenance work or the like is significantly poor because the head part is attached with a fixing screw or a fixing bolt.

There is also a disadvantage in that a printing accuracy varies because the tightness of a bolt changes every time the head part is attached.

The present invention has been made in view of the above-described circumstances, and is directed to providing an ink jet printing apparatus capable of easily attaching and detaching a head part and capable of preventing a printing accuracy from varying as much as possible every time the head part is attached.

The inventors have intensively studied to solve the above-described problems, to find out that the above-described problems can be solved when a printing part includes an urging device for attaching a head part to a line block frame with a base part urged toward the line block frame, to complete the present invention.

The present invention provides an ink jet printing apparatus including a printing part capable of ejecting an ink, in which the printing part includes a plurality of head parts each including a head main body part and a base part provided at a peripheral edge of the head main body part, a line block frame for supporting the base part from below, and an urging device for attaching the base part to the line block frame with the base part urged toward the line block frame, the urging device includes a shaft part attached to the line block frame and extending in an up-down direction, a bracket part attached to the shaft part via a bearing part to enable up-down movement along the shaft part, a spring part attached to the shaft part and for urging the bracket part downward, and a lock pin attached to the bracket part and protruding downward from the bracket part, the lock pin is arranged on an upper surface of the base part at the time of urging, and the lock pin is lifted upward at the time of releasing urging.

In the ink jet printing apparatus according to the present invention, it is preferable that the urging device further includes a grip part attached to the bracket part and protruding upward from the bracket part, and the grip part, the bracket part, and the lock pin are integrally lifted by lifting the grip part.

The ink jet printing apparatus according to the present invention, it is preferable that the bracket part is attached to the shaft part via the bearing part to enable up-down movement along the shaft part and rotational movement around the shaft part, the lock pin is arranged on the upper surface of the base part at the time of urging, and the lock pin is lifted upward and the bracket part is rotated so that the lock pin is arranged at a standby position provided on an upper surface of the line block frame at the time of releasing urging.

At this time, it is more preferable that the standby position is a blind hole provided on the upper surface side of the line block frame, and an upper end surface of the blind hole is positioned above a lower end surface of the lock pin in a case where the lock pin is arranged at the standby position.

In the ink jet printing apparatus according to the present invention, it is preferable that the urging device further includes a block part provided in the bracket part and protruding downward from the bracket part, and the block part is arranged on the upper surface of the line block frame when the lock pin is arranged at the standby position.

In the ink jet printing apparatus according to the present invention, it is preferable that the shaft part includes a small diameter shaft part having a columnar shape and a large diameter shaft part provided on the top of the small diameter shaft part and having a larger diameter than that of the small diameter shaft part, the spring part is inserted into the small diameter shaft part and is sandwiched between the large diameter shaft part and the bracket part, and the spring part includes a coil spring and a disc spring arranged on the underside of the coil spring to be continuous from the coil spring.

In the ink jet printing apparatus according to the present invention, it is preferable that the base part is positioned by contacting a reference pin provided in the line block frame, and the urging device is attached with the base part positioned.

In the ink jet printing apparatus according to the present invention, it is preferable that the base part has a rectangular shape in a top view, a first eccentric pin and a first pressure pin are respectively attached to a position capable of contacting a side surface on the side of one of long sides of the base part and a position capable of contacting a side surface on the side of the other long side and a second eccentric pin and a second pressure pin are respectively attached to a position capable of contacting a side surface on the side of one of short sides of the base part and a position capable of contacting a side surface on the side of the other short side in the line block frame, the first pressure pin urges the base part in a direction perpendicular to a longitudinal direction, the second pressure pin urges the base part in the longitudinal direction, and a position of the base part is finely adjusted by rotating the first eccentric pin and/or the second eccentric pin.

At this time, it is more preferable that a force for the spring part to urge the base part downward is smaller than a force for the first pressure pin or the second pressure pin to laterally urge the base part.

In the ink jet printing apparatus according to the present invention, the printing part includes the urging device. Accordingly, the base part in the head part can be attached to the line block frame with the base part urged toward the line block frame.

That is, in the urging device, the bracket part is urged downward by the spring part. Accordingly, when the lock pin attached to the bracket part is arranged on the upper surface of the base part, the base part is urged downward.

In the ink jet printing apparatus, the bracket part is movable up and down along the shaft part. Accordingly, when the lock pin, together with the bracket part, is lifted, the urging of the base part is released.

These make it possible to easily attach and detach the head part only by moving the lock pin up and down via the bracket part in the ink jet printing apparatus.

The force for urging the bracket part is due to the spring part. Accordingly, every time the head part is attached, almost the same urging force is applied to the base part.

This makes it possible to prevent a printing accuracy from varying as much as possible every time the head part is attached.

In addition, in the ink jet printing apparatus, if the bracket part is rotationally movable around the shaft part, when the lock pin is lifted upward from an urging position and the bracket part is rotated so that the lock pin is arranged at the standby position provided on the upper surface of the line block frame, urging is released. In this case, in the ink jet printing apparatus, the bracket part is allowed to laterally escape by the rotation, thereby making it possible to easily attach and detach the head part.

At this time, if the standby position is the blind hole provided on the upper surface side of the line block frame, and the upper end surface of the blind hole is positioned above the lower end surface of the lock pin in the case where the lock pin is arranged at the standby position, rotation of the lock pin arranged at the standby position is suppressed by a wall around the blind hole so that the lock pin can be prevented from randomly rotationally moving onto the base part.

In the ink jet printing apparatus, if the urging device further includes the block part provided in the bracket part, when the lock pin is arranged at the standby position, the block part is arranged on the upper surface of the line block frame, whereby the lower surface of the lock pin can be prevented from being damaged due to friction or the like.

In the ink jet printing apparatus according to the present invention, when the urging device includes the grip part, the bracket part and the lock pin are easily lifted, thereby making it possible to attach and detach the head part.

The head part is a precision machine. Generally, the plurality of head parts are densely arranged. Accordingly, when any one of the head parts is attached and detached, the head part may contact the other head part. If the head part contacts the other head part, this results in a shift in position of the head part and may cause a failure in the head part. Accordingly, it is significantly effective in attaching and detaching the head part to lift the bracket part and the lock pin via the grip part.

In the ink jet printing apparatus according to the present invention, it is possible to easily adjust a spring force by further arranging as the spring part not only the coil spring but also the disc spring on the underside of the coil spring to be continuous from the coil spring. That is, a sufficient movement amount in an up-down direction of the bracket part can be ensured by the coil spring that sufficiently expands and contracts in the up-down direction, and a sufficient downward urging force can be applied to the bracket part by the disc spring that can exhibit a sufficient urging force (spring force). In the disc spring, the urging force can be easily adjusted by changing the number of disc springs and the type thereof.

When the disc spring is arranged on the underside of the coil spring, the coil spring urges the bracket part via the disc spring. Accordingly, the coil spring does not directly urge only the bearing part, whereby the bearing part can be prevented from shifting in the up-down direction relative to the bracket part.

In the ink jet printing apparatus according to the present invention, when the urging deice is attached to the base part that is positioned by contacting the reference pin, the base part can be urged toward the line block frame at a desired position. As a result, a position of the base part is not a position that has significantly shifted. Accordingly, a time period required to finely adjust the position of the base part can be significantly reduced.

In the ink jet printing apparatus according to the present invention, at least a position in the direction perpendicular to the longitudinal direction of the base part can be easily finely adjusted by the first pressure pin and the first eccentric pin, and at least a position in the longitudinal direction of the base part can be easily finely adjusted by the second pressure pin and the second eccentric pin.

At this time, the force for the spring part to urge the base part downward is smaller than the force for the first pressure pin or the second pressure pin to laterally urge the base part, thereby making it possible to finely adjust the position of the base part while maintaining the state where the urging device urges the base part.

### BRIEF DESCRIPTIONS OF THE DRAWINGS

FIG. 1 is a side view schematically illustrating an example of an ink jet printing apparatus according to the present embodiment;

FIG. 2 is a see-through plan view illustrating one printing part in the ink jet printing apparatus illustrated in FIG. 1;

FIG. 3A is an enlarged plan view illustrating an urged state and an urging released state by an urging device in one head unit in the printing part illustrated in FIG. 2;

FIG. 3B is an enlarged side view illustrating an urged state and an urging released state by the urging device in the one head unit in the printing part illustrated in FIG. 2;

FIG. 4 is an enlarged side view illustrating a pressure pin used for positioning in the head unit illustrated in FIG. 3A;

FIG. 5 is a cross-sectional view illustrating a first urging device in the urged state, taken along a line A1-A1 illustrated in FIG. 3A, and the first urging device in the urging released state, taken along a line A2-A2 illustrated in FIG. 3A;

FIG. 6 is a cross-sectional view illustrating a second urging device in the urged state, taken along a line B1-B1 illustrated in FIG. 3A, and the second urging device in the urging released state, taken along a line B2-B2 illustrated in FIG. 3A;

FIG. 7 is an explanatory diagram for illustrating respective operations at the time of urging and at the time of releasing urging by the first urging device in the head unit illustrated in FIGS. 3A and 3B; and

FIG. 8 is an explanatory diagram for illustrating respective operations at the time of urging and at the time of releasing urging by the second urging device in the head unit illustrated in FIGS. 3A and 3B.

### DESCRIPTIONS OF THE PREFERRED EMBODIMENTS

A preferred embodiment of the present invention will be described in detail below with reference to the drawings, as needed.

In the drawings, the same elements are respectively denoted by the same reference numerals, and overlapping descriptions will be omitted.

A positional relationship among the top, the bottom, the left, and the right, for example, is based on a positional relationship illustrated in the drawings unless otherwise noted.

Further, dimensional ratios in the drawings are not limited to illustrated ratios.

In the present specification, a conveyance direction of a medium to be printed is referred to as an X-direction, and a width direction of the medium to be printed is referred to as a Y-direction.

In an ink jet printing apparatus according to the present invention is an apparatus for performing printing by ejecting an ink from a head part to a conveyed medium to be printed.

The ink jet printing apparatus is of an on-demand type, and a piezo system, a thermal system, or the like can be adopted as an ejection system.

A serial system or a one-pass system, for example, can be adopted as a printing system.

In an embodiment described below, a one-pass system using a line head is adopted.

The medium to be printed is not particularly limited. For example, paper, a film, a fabric, a non-woven fabric, a metal foil, or the like can be adopted.

The ink is not particularly limited. For example, an ink including a coloring material such as a pigment or a dye or a magnetic material, an aqueous solvent, and a known additive to be added as needed can be adopted.

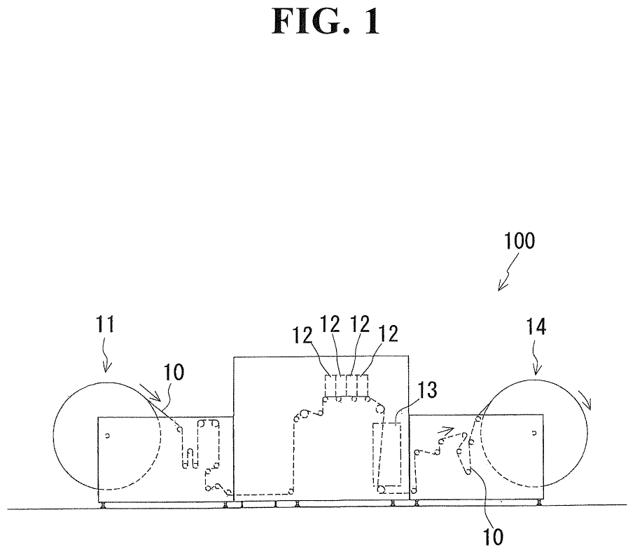

FIG. 1 is a side view schematically illustrating an example of an ink jet printing apparatus 100 according to the present embodiment.

As illustrated in FIG. 1, the ink jet printing apparatus 100 includes a paper feeding part 11 for feeding a medium to be printed 10, a plurality of guide rolls for guiding the fed medium to be printed 10, four printing parts 12 for subjecting the medium to be printed 10 to printing, a drying part 13 for drying the printed medium to be printed 10, and a recovery part 14 for recovering the dried medium to be printed 10.

In the ink jet printing apparatus 100, the paper feeding part 11, the printing parts 12, the drying part 13, and the recovery part 14 are continuous, thereby making it possible to perform processes from feeding of the medium to be printed 10 to printing, drying, and recovery in a series of flows.

As the paper feeding part 11, the guide rolls, the drying part 13, and the recovery part 14, known ones can be appropriately adopted, and hence detailed descriptions thereof will be omitted.

In the ink jet printing apparatus 100, the four printing parts 12 are disposed in series in a conveyance direction of the medium to be printed 10.

Each of the printing parts 12 can independently eject an ink to the medium to be printed 10, which is conveyed below the printing part 12.

In the ink jet printing apparatus 100, different colors of CMYK inks are respectively taken charge of by the printing parts 12, for example, thereby enabling printing in full color.

In the ink jet printing apparatus 100, the four printing parts 12 have the same configuration.

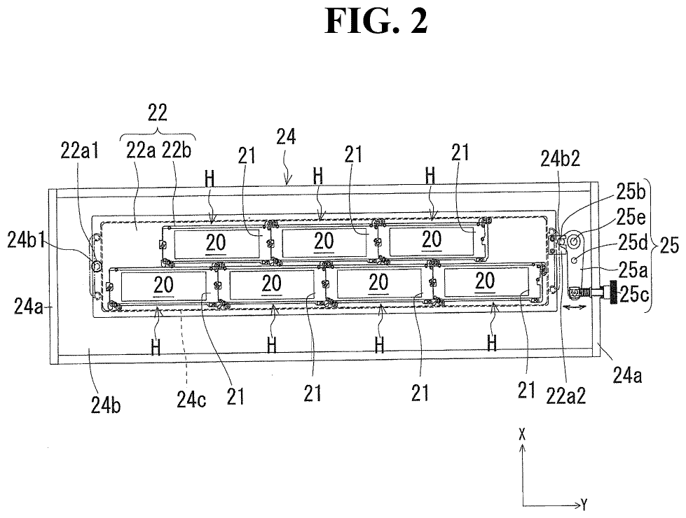

FIG. 2 is a see-through plan view illustrating the one printing part 12 in the ink jet printing apparatus 100 illustrated in FIG. 1. FIG. 2 is a plan view of the printing part 12 seen through a top plate part in a head box 24.

As illustrated in FIG. 2, the printing part 12 includes a box-shaped head box 24, a line block frame 22 supported on a bottom plate part 24b in the head box 24, and a plurality of head units supported on the line block frame 22.

That is, the ink jet printing apparatus 100 includes the four printing parts 12 each including the head box 24, the line block frame 22, and the plurality of head units.

The term “head unit” means one including one head part H and two urging devices 23 for urging a base part 21 in the head part H, as described below. The phrase “having a plurality of head units” means repeatedly having, using the head units as one unit, the unit.

In the printing part 12, the head box 24 is a box having a rectangular parallelepiped shape including the top plate part (not illustrated) on the upper side, the bottom plate part 24b on the lower side, and four side plate parts 24a that connect both the top plate part and the bottom plate part 24b to each other.

The head box 24 houses the plurality of head parts H (the head units) in its inner portion.

The printing part 12 includes the head box 24, whereby foreign matter such as ink mist or dust from outside can be prevented from entering the head box 24 to adhere to the head parts H or the like.

The head box 24 may house a distribution tank (not illustrated) for temporarily storing an ink and distributing the ink among respective head main body parts 20 in the head parts H, a tube (not illustrated) for allowing the ink to flow, or the like.

In the head box 24, a line hole part 24c having a rectangular shape in a top view is formed at a substantial center in the bottom plate part 24b.

The line block frame 22 is attached to the bottom plate part 24b to close the line hole part 24c. That is, the line block frame 22 is supported from below on a peripheral edge of the line hole part 24c in the bottom plate part 24b.

As a result, a lower surface of the line block frame 22, except for its portion contacting the bottom plate part 24b, enters an exposed state.

In the head box 24, the bottom plate part 24b is provided with a pin or the like for positioning the line block frame 22. That is, in the bottom plate part 24b, a first positioning pin 24b1 and a second positioning pin 24b2 are respectively provided at positions on both sides of the line hole part 24c in a Y-direction.

The second positioning pin 24b2 is attached to a direction adjustment device 25 described below.

The head box 24, together with the housed head part H and the like, can reciprocate along a rail (not illustrated) extending in the Y-direction.

Therefore, in the ink jet printing apparatus 100, the head box 24 can be moved in a timely manner to a printing position where printing is to be performed, a maintenance position where the head part H is to be maintained, a storage position where the head part H is to be stored, and the like, which are provided along the rail.

A linear motion mechanism such as an air cylinder or a ball screw is preferably used for such movement.

In the printing part 12, the line block frame 22 is a frame having a rectangular plate shape in a top view and for mounting the plurality of head parts H.

The line block frame 22 includes a frame main body part 22a, a plurality of head hole parts (not illustrated) provided in the frame main body part 22a, and a support part 22b provided at a peripheral edge of each of the head hole parts and provided to protrude into the head hole part from the frame main body part 22a.

Here, an upper surface of the support part 22b and an upper surface of the frame main body part 22a are substantially parallel to each other, and the upper surface of the support part 22b is positioned below the upper surface of the frame main body part 22a. That is, in the line block frame 22, the frame main body part 22a and the support part 22b have a stepped shape in a side view.

In the line block frame 22, the frame main body part 22a is provided with a pin hole or the like for positioning relative to the bottom plate part 24b.

That is, the frame main body part 22a has a positioning pin hole 22a1 provided at its position corresponding to the first positioning pin 24b1, and has a positioning pin receiving part 22a2 at its position corresponding to the second positioning pin 24b2. Therefore, when the line block frame 22 is attached to the bottom plate part 24b, the first positioning pin 24b1 is inserted into the positioning pin hole 22al in the line block frame 22, and the second positioning pin 24b2 attached to the direction adjustment device 25 is fitted in the positioning pin receiving part 22a2 in the line block frame 22, thereby making it possible to roughly position the line block frame 22 relative to the bottom plate part 24b. This can result in a time period required to finely adjust a position of the line block frame 22 relative to the bottom plate part 24b being significantly shortened.

The direction adjustment device 25 has a Z shape, and includes a plate-shaped adjustment main body part 25a, an attachment part 25b provided to protrude toward the line block frame 22 from one end of the adjustment main body part 25a, and a direction adjustment knob 25c provided to protrude toward the opposite side to the line block frame 22 at the other end of the adjustment main body part 25a.

The second positioning pin 24b2 is attached to the attachment part 25b, and the direction adjustment knob 25c is supported on the side plate part 24a in the head box 24 to be exposed to the outside of the head box 24.

The adjustment main body part 25a has its one end rotatably attached to an upper end of a center shaft 25e vertically extending.

The center shaft 25e has its lower end fixed and attached to the bottom plate part 24b.

The adjustment main body part 25a has a center positioning pin hole 25d provided at its substantially central position, and is arranged to match a pin hole provided in the bottom plate part 24b using a pin or the like so that the adjustment main body part 25a is positioned relative to the bottom plate part 24b.

In the direction adjustment device 25, when the direction adjustment knob 25c is operated, the attachment part 25b can be finely turned with the center shaft 25e as its axis.

At this time, the positioning pin receiving part 22a2 in the line block frame 22 is fitted in the second positioning pin 24b2 attached to the attachment part 25b in the direction adjustment device 25. Accordingly, the side of the positioning pin receiving part 22a2 in the line block frame 22, together with the attachment part 25b in the direction adjustment device 25, finely turns. That is, in this case, in the line block frame 22, the side of the positioning pin receiving part 22a2 finely turns with the first positioning pin 24b1 as its axis.

Therefore, in the printing part 12, the direction adjustment device 25 is enabled to finely adjust a position of the line block frame 22 relative to the bottom plate part 24b.

In the printing part 12, the head part H (the head unit) is attached to close the head hole part to the support part 22b in the line block frame 22. That is, the base part 21 in the head part H is supported from below on the support part 22b, as the peripheral edge of the head hole part, in the line block frame 22.

As a result, a lower surface of the head part H, except for its portion contacting the support part 22b in the line block frame 22, enters an exposed state.

In the line block frame 22, head hole parts and support parts 22b are provided at seven positions to have a staggered shape in a top view, and the head parts H are respectively attached to the support parts 22b.

Specifically, in the line block frame 22, the head parts H are provided in two columns in an X-direction, where the four head parts H are provided in parallel in the Y-direction in one of the columns, the three head parts H are provided in parallel in the Y-direction in the other column, and respective positions in the X-direction of the head parts H in the one column and the head parts H in the other column are arranged to alternate with each other.

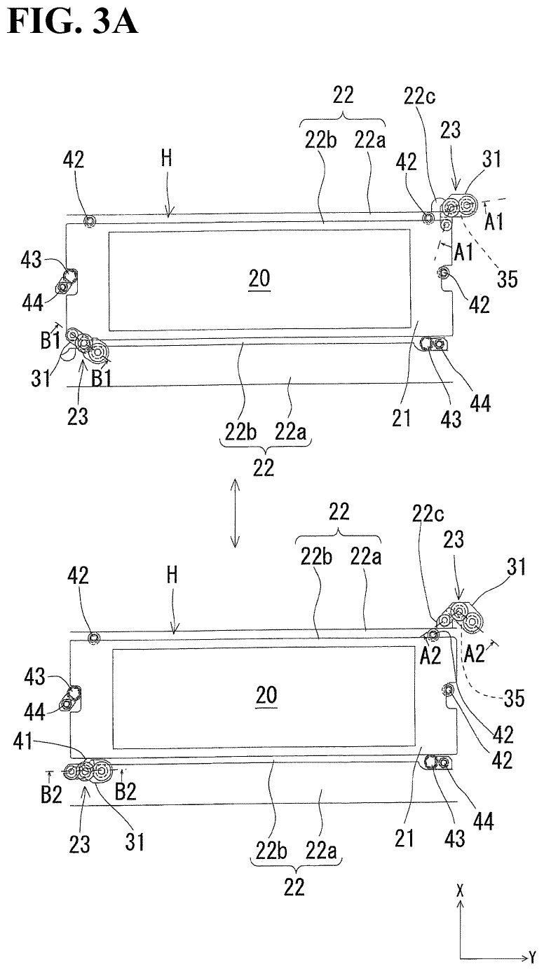

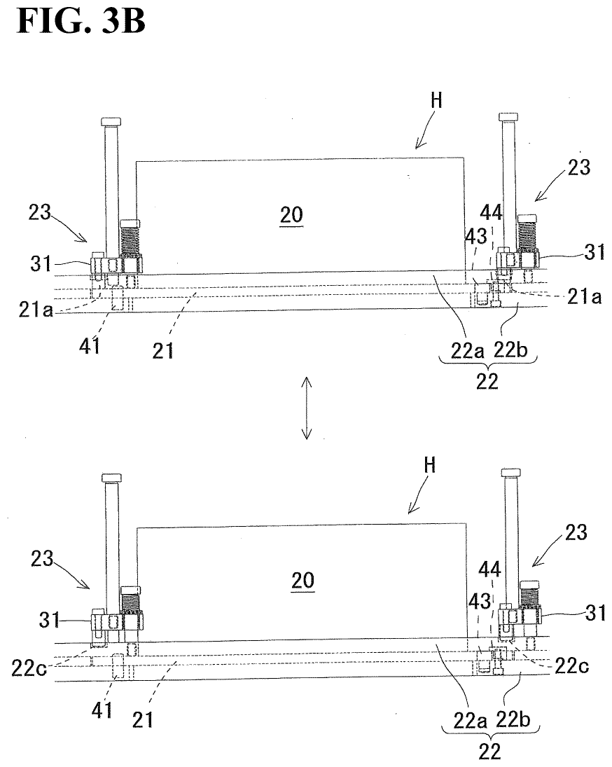

FIG. 3A is an enlarged plan view illustrating an urged state (on the upper side of FIGS. 3A and 3B) and an urging released state (on the lower side of FIGS. 3A and 3B) by the urging device 23 in the one head unit in the printing part 12 illustrated in FIG. 2, and FIG. 3B is an enlarged side view corresponding to FIG. 3A. In FIG. 3B, description of a positioning pin is omitted.

As illustrated in FIGS. 3A and 3B, the head unit includes the head part H including the head main body part 20 and the plate-shaped base part 21 provided at a peripheral edge of the head main body part 20 and urging device 23 for attaching the base part 21 to the line block frame 22 with the base part 21 urged toward the line block frame 22. That is, the printing part 12 includes the plurality of head parts H, the line block frame 22 for supporting the base parts 21 in the head parts H from below at the same time, and the urging device 23 for attaching each of the base parts 21 to the line block frame 22 with the base part 21 urged toward the line block frame 22.

In the printing part 12, the head main body part 20 and the base part 21 in the head part H have an integral structure.

The head parts H in the plurality of head units have the same structure.

That is, the seven head parts H illustrated in FIG. 2 have the same structure.

In the head unit, the base part 21 in the head part H is positioned relative to the line block 22 by a reference pin 41, a pressure pin 42, and an eccentric pin 43 that are attached to the support part 22b in the line block frame 22.

Here, the reference pin 41 is a normal pin, the eccentric pin 43 is a pin being rotatable and having a center at its position eccentric with respect to a rotation center, and the pressure pin 42 is a pin capable of laterally exhibiting a spring force.

The eccentric pin 43 is also referred to as a first eccentric pin 43 or a second eccentric pin 43, as needed. Similarly, the pressure pin 42 is also referred to as a first pressure pin 42 or a second pressure pin 42.

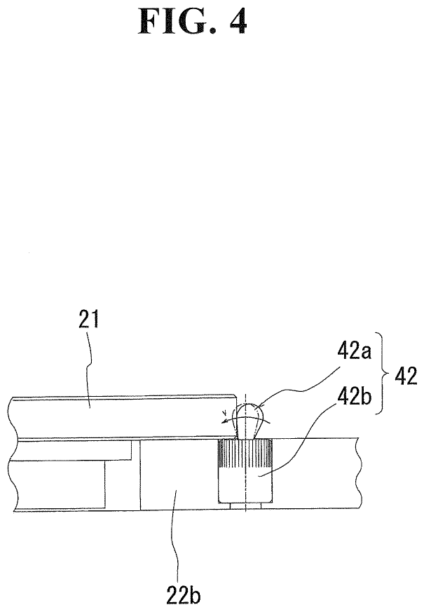

FIG. 4 is an enlarged side view illustrating a pressure pin used for positioning in the head unit illustrated in FIG. 3A.

As illustrated in FIG. 4, the pressure pin 42 used for positioning the base part 21 includes a head part 42a and a body part 42b.

In the pressure pin 42, the body part 42b contains a coil spring. When the head part 42a is laterally pressed by the base part 21, a stress based on a spring force of the coil spring is exerted.

At this time, in the pressure pin 42, the head part 42a has an oval shape. Accordingly, as a stress to be exerted in a circular arc direction around a lower end of the head part 42a, not only a force in a direction toward the base part 21 but also a force for urging the base part 21 downward can be sufficiently exhibited.

Referring to FIG. 3A again, in the support part 22b in the line block frame 22, the reference pin 41 and the first eccentric pin 43 are respectively attached at a predetermined distance to positions capable of contacting a side surface on the side of one of long sides of the base part 21, and the two first pressure pins 42 are respectively attached at a predetermined distance to positions capable of contacting a side surface on the side of the other long side.

The reference pin 41 and the one first pressure pin 42 are arranged at positions that oppose each other and the first eccentric pin 43 and the other first pressure pin 42 are arranged at positions that oppose each other, respectively, with the base part 21 interposed therebetween.

Therefore, in the base part 21, the first pressure pin 42 urges the base part 21 in the X-direction (a direction perpendicular to a longitudinal direction). When the first eccentric pin 43 is rotated, the base part 21 is enabled to finely adjust a position in a rotation direction around the reference pin 41, i.e., at least a position in the direction perpendicular to the longitudinal direction of the base part 21 on an XY plane.

In the support part 22b in the line block frame 22, the second eccentric pin 43 is attached to a position capable of contacting a side surface on the side of one of short sides of the base part 21, and the second pressure pin 42 is attached to a position capable of contacting a side surface on the side of the other short side.

Therefore, in the base part 21, the second pressure pin 42 urges the base part 21 in the Y-direction (the longitudinal direction). When the second eccentric pin 43 is rotated, the base part 21 is enabled to finely adjust at least a position in the longitudinal direction of the base part 21.

As the fine adjustment of the position of the base part 21, a position in the direction perpendicular to the longitudinal direction of the base part 21 is first finely adjusted by rotating the first eccentric pin 43. In the case, a position in the longitudinal direction of the base part 21 also shifts. Accordingly, the position in the longitudinal direction of the base part 21 is then preferably finely adjusted by rotating the second eccentric pin 43.

In addition, a stopper 44 for preventing the eccentric pin 43 from rotating, for example, is attached to the line block frame 22 to be adjacent to the eccentric pin 43.

The stopper 44 presses an upper surface of the eccentric pin 43 from above by tightening a locking screw.

This makes it possible to prevent the eccentric pin 43 from randomly rotating after finishing the fine adjustment of the position by the eccentric pin 43, for example.

In the head part H, the base part 21 is preferably attached to the line block frame 22 by the urging device 23 with the base part 21 positioned to some extent relative to the line block frame 22. As a result, a position of the base part 21 is not a position that has significantly shifted. Accordingly, a time period required to finely adjust a position of the head part H can be significantly shortened.

A force for a spring part 32, described below, in the urging device 23 to urge the base part 21 downward is preferably smaller than a force for the pressure pin 42 to laterally urge the base part 21. In this case, it is possible to finely adjust a lateral position of the base part 21 while maintaining a state where the urging device 23 urges the base part 21.

Referring to FIGS. 2, 3A, and 3B again, in the head parts H, all the head main body parts 20 have each a substantially rectangular parallelepiped shape, and are used for temporarily housing an ink and ejecting the ink.

Each of the head main body parts 20 has a plurality of nozzles formed on its lower surface, and is enabled to eject an ink supplied thereinto from the nozzles.

The nozzles formed on the lower surface of the head main body part 20 are exposed via the head hole parts in the line block frame 22 and the line hole part 24c in the head box 24, described above. Accordingly, the head main body part 20 is enabled to eject an ink toward the medium to be printed 10 that is conveyed below the printing part 12.

In the head unit, the urging device 23 is a device for attaching the base part 21 to the line block frame 22 while urging the base part 21 toward the line block frame 22. In the head unit, even after the urging device 23 attaches the head part H to the line block frame 22, the urging by the urging device 23 is maintained.

On the other hand, the urging device 23 is also enabled to forcedly release its urging force. As a result, the head part H can be easily taken out.

As the urging device 23, two urging devices are provided for one base part 21.

Specifically, the urging devices 23 are respectively arranged at diagonal positions of the base part 21. As a result, the base part 21 is urged downward with a force that is as uniform as possible by the urging devices 23 throughout its extent.

The two urging devices 23 have the same configuration except that they respectively include bracket parts 31 having different shapes.

Hereinafter, for convenience, the urging device 23 (the urging device at the upper right of the head unit illustrated in FIG. 3A) including the bracket part 31 having an L shape in a top view is referred to as a “first urging device 23”, and the urging device 23 (the urging device at the lower left of the head unit illustrated in FIG. 3A) including the bracket part 31 having a rectangular shape in a top view is hereinafter referred to as a “second urging device 23”. The term “urging device 23” refers to both the first urging device 23 and the second urging device 23.

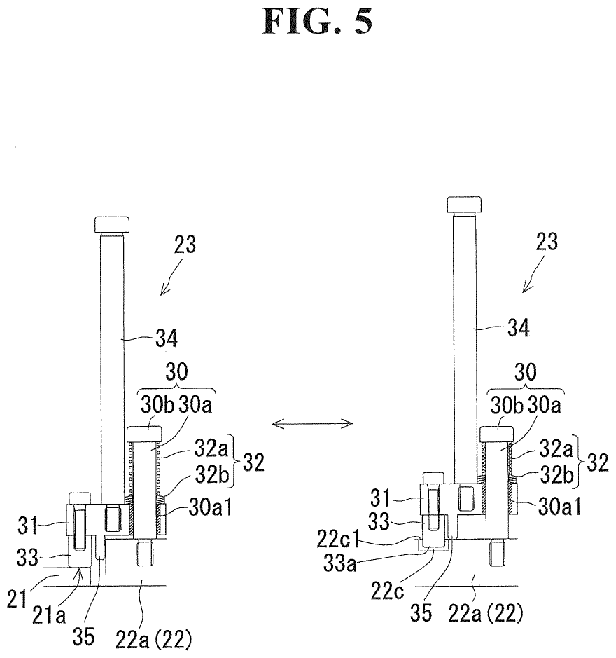

FIG. 5 is a cross-sectional view illustrating the first urging device (on the left side in FIG. 5) in a urged state, taken along a line A1-A1 illustrated in FIG. 3A, and the first urging device (on the right side in FIG. 5) in an urging released state, taken along a line A2-A2 illustrated in FIG. 3A.

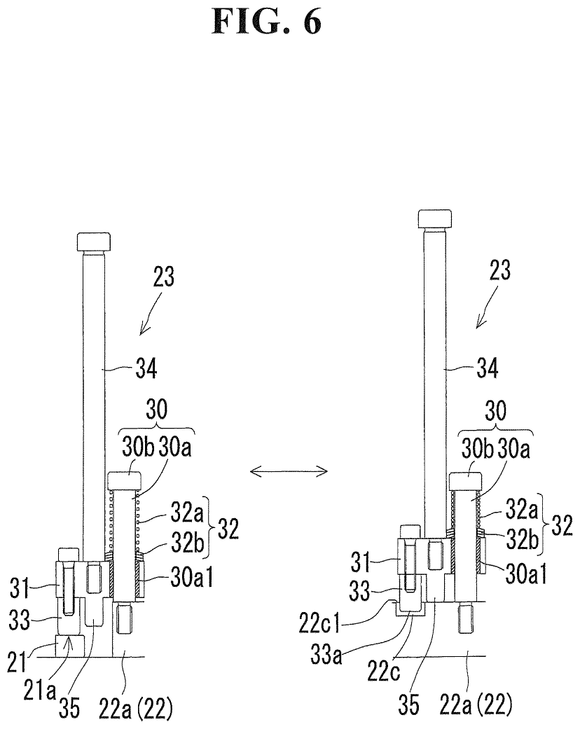

FIG. 6 is a cross-sectional view illustrating the second urging device (on the left side in FIG. 6) in a urged state, taken along a line B1-B1 illustrated in FIG. 3A, and the second urging device (on the right side in FIG. 6) in an urging released state, taken along a line B2-B2 illustrated in FIG. 3A.

As illustrated in FIGS. 5 and 6, the urging device 23 includes a shaft part 30 attached to the frame main body part 22a in the line block frame 22 and extending in an up-down direction, a bracket part 31 attached to the shaft part 30 via a bearing part 30al to enable up-down movement along the shaft part 30, a spring part 32 attached to the shaft part 30 and for urging the bracket part 31 downward, a grip part 34 attached to the bracket part 31 and protruding upward from the bracket part 31, a lock pin 33 attached to the bracket part 31 and protruding downward from the bracket part 31, and a block part 35 provided in the bracket part 31 and protruding downward from the bracket part 31.

In the urging device 23, the shaft part 30 includes a small diameter shaft part 30a having a columnar shape extending in the up-down direction and a large diameter shaft part 30b provided on the top of the small diameter shaft part 30a and having a larger diameter than that of the small diameter shaft part 30a.

In the shaft part 30, the small diameter shaft part 30a has its lower end serving as a screw portion, and is screwed into a screw hole provided in the frame main body part 22a in the line block frame 22.

The bearing part 30a1 (an oil-free bush) is attached to a lower portion of the small diameter shaft part 30a, and the bracket part 31 is attached thereto via the bearing part 30a1.

The spring part 32 is attached to a middle abdomen portion of the small diameter shaft part 30a to surround the middle abdomen portion, and the spring part 32 is sandwiched between the large diameter shaft part 30b and the bracket part 31.

In the first urging device 23, the bracket part 31 has an L plate shape in a top view having a surface extending horizontally. In the second urging device 23, the bracket part 31 has a rectangular plate shape in a top view having a surface extending horizontally.

The urging device 23 is provided with the grip part 34, the lock pin 33, and the block part 35.

That is, the bracket part 31 is integrated with the bearing part 30a1, the grip part 34, the lock pin 33, and the block part 35.

The bracket part 31 is integrated with the bearing part 30a1, the grip part 34, the lock pin 33, and the block part 35, to enable up-down movement along a length of the shaft part 30 (the small diameter shaft part 30a) and rotational movement with the shaft part 30 (the small diameter shaft part 30a) as its axial center.

At this time, the bracket part 31 is attached to the small diameter shaft part 30a in the shaft part 30 via the bearing part 30a1, thereby making it possible to smoothly perform up-down movement and rotational movement.

In the urging device 23, the spring part 32 is inserted into the small diameter shaft part 30a, and is sandwiched between the large diameter shaft part 30b and the bracket part 31, as described above. Accordingly, the spring part 32 can expand and contract by an amount corresponding to the length of the small diameter shaft part 30a.

The spring part 32 is sandwiched between the large diameter shaft part 30b and the bracket part 31 in a contracted state. Accordingly, a downward spring force (urging force) is always applied to the bracket part 31 with the large diameter shaft part 30b as an origin.

Here, examples of the spring part 32 to be adopted include a coil spring (coil-shaped push spring), a leaf spring, and a disc spring.

Among them, as the spring part 32, the coil spring or the disc spring is preferably adopted, and the coil spring and the disc spring are more preferably adopted.

Specifically, the spring part 32 preferably includes a coil spring 32a and a disc spring 32b arranged on the underside of the coil spring 32a to be continuous from the coil spring 32a.

In this case, the spring part 32 is enabled to easily adjust a spring force.

When the disc spring 32b is arranged on the underside of the coil spring 32a, the coil spring 32a urges the bracket part 31 via the disc spring 32b. Accordingly, the coil spring 32a does not directly urge only the bearing part 30a1, whereby the bearing part 30al can be prevented from shifting in the up-down direction relative to the bracket part 31.

In the urging device 23, the lock pin 33 has a columnar shape, and has its upper end attached and fixed to the bracket part 31 with a fastener such as a bolt.

The lock pin 33 has its lower end being flat, and is arranged at an urging position 21a on the base part 21 at the time of urging and is arranged at a standby position 22c on the line block frame 22 at the time of releasing urging.

Here, the standby position 22c is a blind hole provided in the line block frame 22 (see FIGS. 3A and 3B) and provided on the upper surface side of the line block frame 22.

At the standby position 22c, an upper end surface 22cl of the blind hole is positioned above a lower end surface 33a of the lock pin 33 in a case where the lock pin 33 is arranged at the standby position 22c.

As a result, the lock pin 33 arranged at the standby position 22c contacts a wall around the blind hole, whereby the bracket part 31 can be prevented from randomly rotationally moving.

In the urging device 23, the grip part 34 has a columnar shape, is arranged between the shaft part 30 and the lock pin 33, has its lower end serving as a screw portion, and is screwed into a screw hole provided in the bracket part 31. Accordingly, when the grip part 34 is lifted, the grip part 34, the bracket part 31, the bearing part 30a1, the lock pin 33, and the block part 35 are integrally lifted.

The grip part 34 is provided to protrude upward from the bracket part 31, and has its upper end positioned above the large diameter shaft part 30b. Accordingly, in the urging device 23, the grip part 34 is easily gripped.

In the urging device 23, the grip part 34 makes it easy to lift the bracket part 31 and the lock pin 33, thereby making it possible to easily perform up-down movement of the bracket part 31 relative to the shaft part 30 and rotational movement of the bracket part 31 with the shaft part 30 as its axis.

In the urging device 23, the block part 35 is formed integrally with the bracket part 31.

The block part 35 has a block shape, and is arranged on the upper surface of the frame main body part 22a when the lock pin 33 is arranged at the standby position 22c. As a result, the entire urging device 23 is supported by the block part 35.

At this time, a lower surface of the lock pin 33 is preferably in a floating state where it does not contact a bottom surface of the blind hole as the standby position 22c and is spaced apart therefrom by a predetermined distance. This makes it possible to prevent the lower surface of the lock pin 33 from being damaged due to friction or the like.

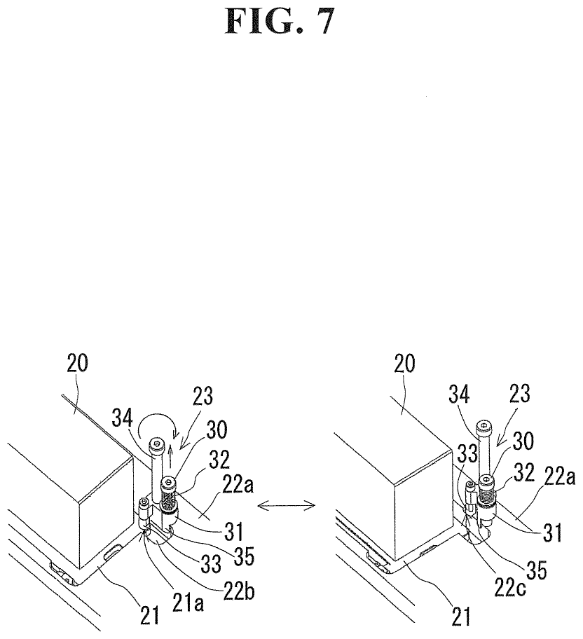

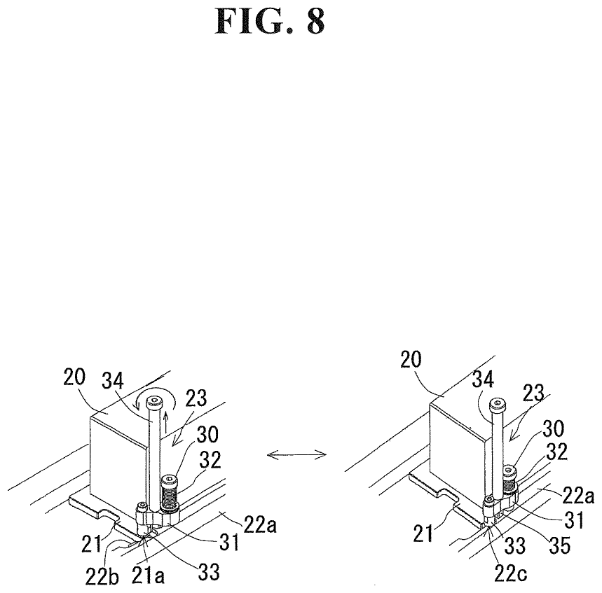

FIG. 7 is an explanatory diagram for illustrating respective operations at the time of urging (on the left side of FIG. 7) and at the time of releasing urging (on the right side in FIG. 7) by the first urging device in the head unit illustrated in FIGS. 3A and 3B, and FIG. 8 is an explanatory diagram for illustrating respective operations at the time of urging (on the left side in FIG. 8) and at the time of releasing urging (on the right side in FIG. 8) by the second urging device in the head unit illustrated in FIGS. 3A and 3B.

As illustrated in FIGS. 7 and 8, the lock pin 33 in the urging device 23 is arranged at the urging position 21a on the base part 21 at the time of urging.

At this time, the bracket part 31 is urged downward by the spring part 32. Accordingly, the base part 21 is urged toward the support part 22b in the line block frame 22 therebelow via the lock pin 33.

That is, in the ink jet printing apparatus 100, when the lock pin 33 in the urging device 23 is arranged on an upper surface of the base part 21 in the head part H, the head part His urged downward.

When the grip part 34 in the urging device 23 is lifted upward from this state, the bracket part 31 upwardly moves along the shaft part 30, and the lock pin 33 is also simultaneously lifted. As a result, the urging is released.

That is, in the ink jet printing apparatus 100, when the lock pin 33 in the urging device 23 is lifted, the urging is released.

In this case, a downward urging force due to the spring part 32 is applied to the bracket part 31. Accordingly, the grip part 34 is forcedly lifted with a force exceeding the urging force.

Then, when the grip part 34 in the urging device 23 is rotated, the bracket part 31 rotationally moves with the shaft part 30 as its center, and the lock pin 33 is also simultaneously rotated.

Such rotational movement is performed from a position where the lock pin 33 is above the urging position 21a to a position where the lock pin 33 is above the standby position 22c.

When the grip part 34 in the urging device 23 is lifted downward, the bracket part 31 downwardly moves along the shaft part 30, and the lock pin 33 is arranged at the standby position 22c. The lock pin 33 and the bottom surface of the standby position 22c as the blind hole do not contact each other, as described above.

At this time, the block part 35 provided in the bracket part 31 is arranged on the upper surface of the frame main body part 22a in the line block frame 22. As a result, the urging device 23 enters a state where it is supported by the frame main body part 22a.

When the lock pin 33 is moved to the urging position 21a from the standby position 22c, operations reverse to the above-described operations may be performed.

Thus, in the ink jet printing apparatus 100, it is possible to easily attach and detach the head part H by only moving the lock pin 33 up and down via the bracket part 31.

A force for urging the bracket part 31 is due to the spring part 32. Accordingly, every time the head part His attached, almost the same urging force is applied to the base part 21.

This makes it possible to prevent a printing accuracy in the head part H from varying as much as possible every time the head part H is attached.

The bracket part 31 is rotationally moved around the shaft part 30 to allow the lock pin 33 to laterally escape to the standby position 22c, thereby making it possible to more easily attach and detach the head part H.

Although the embodiment of the present invention has been described above, the present invention is not limited to the above-described embodiment.

Although the ink jet printing apparatus 100 according to the present embodiment includes the paper feeding part 11, the printing part 12, the drying part 13, and the recovery part 14, the paper feeding part 11, the drying part 13, and the recovery part 14 may be respectively separate members.

Although in the ink jet printing apparatus 100 according to the present embodiment, the one line block frame 22 having the head part H mounted thereon is attached to the bottom plate part 24b in the head box 24, a plurality of line block frames each having head parts H mounted thereon may be attached.

Although the head parts H are attached at seven positions to have a staggered shape in a top view to the line block frame 22 in the ink jet printing apparatus 100 according to the present embodiment, the number of head parts H and a position to which each of the head parts H is attached are not limited to these.

Although the positioning pins, the direction adjustment device 25, and the like are used for positioning the line block frame 22 relative to the bottom plate part 24b in the head box 24 in the ink jet printing apparatus 100 according to the present embodiment, a positioning method is not limited to this.

Similarly, although the reference pin 41, the pressure pin 42, the eccentric pin 43, and the like are used for positioning the base part 21 relative to the line block frame 22, a positioning method is not limited to this.

Although the two urging devices 23 are provided for the one base part 21 in the head unit in the ink jet printing apparatus 100 according to the present embodiment, the present invention is not limited to this, but the number of urging devices 23 to be provided may be one or three or more.

Positions where the urging devices 23 are provided are not respectively limited to diagonal positions of the base part 21 either.

Both a side surface of the block part 35 and a side surface of the frame main body part 22a in the line block frame 22 may contact each other, although a space is formed therebetween at the time of urging when the lock pin 33 is arranged on the base part 21 in the ink jet printing apparatus 100 according to the present embodiment. In this case, the contact therebetween can also be used for positioning the urging device 23 at the urging position 21a.

In the urging device 23 in the ink jet printing apparatus 100 according to the present embodiment, although the lower end of the shaft part 30 is the screw portion, and the shaft part 30 is screwed into the screw hole provided in the frame main body part 22a in the line block frame 22, an attachment method is not limited to this.

Similarly, although the lower end of the grip part 34 is the screw portion, and the grip part 34 is screwed into the screw hole provided in the bracket part 31, an attachment method is not limited to this.

In the urging device 23 in the ink jet printing apparatus 100 according to the present embodiment, the block part 35 and the bracket part 31 are integrally formed, but may be respectively separate members.

Although the upper end of the lock pin 33 is attached and fixed to the bracket part 31 with a fastener such as a bolt, an attachment method is not limited to this.

Although both the lock pin 33 and the grip part 34 each have a columnar shape, the present invention is not limited to this, but the lock pin 33 and the grip part 34 may each have a polygonal shape or the like.

The ink jet printing apparatus according to the present invention can be used as an apparatus capable of forming a pattern or the like by applying an ink to a medium to be printed.

With the ink jet printing apparatus according to the present invention, it is possible to easily attach and detach a head part and to prevent a printing accuracy from varying as much as possible every time the head part is attached.

### REFERENCE SIGNS LIST

10 . . . Medium to be printed
100 . . . Ink jet printing apparatus
11 . . . Paper feeding part
12 . . . Printing part
13 . . . Drying part
14 . . . Recovery part
20 . . . Head main body part
21 . . . Base part
21a . . . Urging position
22 . . . Line block frame
22a . . . Frame main body part
22a1 . . . Positioning pin hole
22a2 . . . Positioning pin receiving part
22b . . . Support part
22c . . . Standby position
22cl . . . Upper end surface of a blind hole
23 . . . Urging device
24 . . . Head box
24a . . . Side plate part
24b . . . Bottom plate part
24b1 . . . First positioning pin
24b2 . . . Second positioning pin
24c . . . Line hole part
25 . . . Direction adjustment device
25a . . . Adjustment main body part
25b . . . Attachment part
25c . . . Direction adjustment knob
25d . . . Center positioning pin hole
25e . . . Center shaft
30 . . . Shaft part
30a . . . Small diameter shaft part
30b . . . Large diameter shaft part
30al . . . Bearing part
31 . . . Bracket part
32 . . . Spring part
32a . . . Coil spring
32b . . . Disc spring
33 . . . Lock pin
33a . . . Lower end surface of a lock pin
34 . . . Grip part
35 . . . Block part
41 . . . Reference pin
42 . . . Pressure pin
42a . . . Head part
42b . . . Body part
43 . . . Eccentric pin
44 . . . Stopper
H . . . Head part

What is claimed is:

1. An ink jet printing apparatus including a printing part capable of ejecting an ink, wherein
the printing part includes a plurality of head parts each including a head main body part and a base part provided at a peripheral edge of the head main body part, a line block frame for supporting the base part from below, and an urging device for attaching the base part to the line block frame with the base part urged toward the line block frame,
the urging device includes a shaft part attached to the line block frame and extending in an up-down direction, a bracket part attached to the shaft part via a bearing part to enable up-down movement along the shaft part, a spring part attached to the shaft part and for urging the bracket part downward, and a lock pin attached to the bracket part and protruding downward from the bracket part,
the lock pin is arranged on an upper surface of the base part at the time of urging, and
the lock pin is lifted upward at the time of releasing urging.

2. The ink jet printing apparatus according to claim 1, wherein
the urging device further includes a grip part attached to the bracket part and protruding upward from the bracket part, and
the grip part, the bracket part, and the lock pin are integrally lifted by lifting the grip part.

3. The ink jet printing apparatus according to claim 1, wherein
the bracket part is attached to the shaft part via the bearing part to enable up-down movement along the shaft part and rotational movement around the shaft part,
the lock pin is arranged on the upper surface of the base part at the time of urging, and
the lock pin is lifted upward and the bracket part is rotated so that the lock pin is arranged at a standby position provided on an upper surface of the line block frame at the time of releasing urging.

4. The ink jet printing apparatus according to claim 3, wherein
the standby position is a blind hole provided on the upper surface side of the line block frame, and
an upper end surface of the blind hole is positioned above a lower end surface of the lock pin in a case where the lock pin is arranged at the standby position.

5. The ink jet printing apparatus according to claim 3, wherein
the urging device further includes a block part provided in the bracket part and protruding downward from the bracket part, and
the block part is arranged on the upper surface of the line block frame when the lock pin is arranged at the standby position.

6. The ink jet printing apparatus according to claim 1, wherein
the shaft part includes a small diameter shaft part having a columnar shape and a large diameter shaft part provided on the top of the small diameter shaft part and having a larger diameter than that of the small diameter shaft part,
the spring part is inserted into the small diameter shaft part and is sandwiched between the large diameter shaft part and the bracket part, and
the spring part includes a coil spring and a disc spring arranged on the underside of the coil spring to be continuous from the coil spring.

7. The ink jet printing apparatus according to claim 1, wherein
the base part is positioned by contacting a reference pin provided in the line block frame, and
the urging device is attached with the base part positioned.

8. The ink jet printing apparatus according to claim 1, wherein
the base part has a rectangular shape in a top view,
a first eccentric pin and a first pressure pin are respectively attached to a position capable of contacting a side surface on the side of one of long sides of the base part and a position capable of contacting a side surface on the side of the other long side and a second eccentric pin and a second pressure pin are respectively attached to a position capable of contacting a side surface on the side of one of short sides of the base part and a position capable of contacting a side surface on the side of the other short side in the line block frame,
the first pressure pin urges the base part in a direction perpendicular to a longitudinal direction,
the second pressure pin urges the base part in the longitudinal direction, and
a position of the base part is finely adjusted by rotating the first eccentric pin and/or the second eccentric pin.

9. The ink jet printing apparatus according to claim 8, wherein a force for the spring part to urge the base part downward is smaller than a force for the first pressure pin or the second pressure pin to laterally urge the base part.
